(19) United States
(12) Patent Application Publication
(10) Pub. No.: US 2002/0059612 A1
(43) Pub. Date: May 16, 2002

(54) Method for allocating satellite channel, a satellite communications system and an earth station for satellite communications

(75) Inventor: Tomohiro Kita, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Mitsubishi Denki Kabushiki Kaisha, Tokyo (JP)

(21) Appl. No.: 09/842,163

(22) Filed: Apr. 26, 2001

(30) Foreign Application Priority Data
Apr. 26, 2000 (JP) 2000-125669

(51) Int. Cl. H04N 7/20

(52) U.S. Cl. 725/64

(57) ABSTRACT

The satellite communications system according to the present invention transmits data from the VSAT to the HUB through a fixedly predetermined first forward satellite channel. The HUB, on receiving a request for allocation of a second forward satellite channel having a greater frequency band than that of the first forward satellite channel, allocates the second forward satellite channel to the VSAT concerned on condition that the second forward satellite channel being unoccupied. According to this architecture, mass data can be transmitted effectively using the second forward satellite channel having a larger capacity than that of the first forward satellite channel.

### BACKGROUND OF THE INVENTION

1. Field of the Invention

The present invention relates to a method for allocating satellite channel used in a satellite communications system performing bi-directional data communications between a central station and a plurality of remote stations and having a fixedly predetermined forward satellite channel used for data transmission from the plurality of remote stations, and the aforementioned satellite communications system and an earth station for satellite communications applied to the satellite communications system concerned.

2. Background Art

Conventionally, a satellite communications system is known in which data is transmitted bi-directionally via a satellite between a central station as one of the earth stations at central side (hereinafter referred to as “HUB”) and a remote station as one of the plurality of earth stations at remote side (hereinafter referred to as “VSAT” i.e. Very Small Aperture Terminal). In the satellite communications system of this kind, data such as picture image or music are transmitted to VSAT through backward satellite channel, while data such as acknowledgement of receiving data (ACK) is transmitted to the HUB through forward satellite channel. The satellite communications system of this kind is applied to such case for providing a various data delivery service from the data delivery businessmen concerned to a plurality of subscribers.

By the way, in the aforementioned satellite communications system , all the satellite channel available for the HUB and the VSAT are fixedly set beforehand. The backward channel available for the HUB corresponds to a relatively wide downlink frequency so as to realize effective mass transmission of data such as picture image. In case of data transmission, the HUB generates radio signal-by modulating data to nestle them into the aforementioned downlink frequency band and sends out the radio signal to the VSAT via a satellite.

On the other hand, the channel available for the VSAT corresponds to an uplink frequency band having relatively narrow range just so much as to transmit small amount of data such as ACK and also it corresponds to either one of the time slots set within a predetermined frame. In other words, in case of data transmission VSAT generates radio signal by modulating data to nestle them into the aforementioned downlink frequency band and sends the radio signal to VSAT via satellite at a timing in synchronization with any given time slot among the aforementioned plural time slots.

In the aforementioned satellite communications system, the data to be transmitted from the VSAT to the HUB is supposed to have relatively small amount such as ACK. However, it may also be considered of a case generating a request-to-send mass data having a large amount in the VSAT. In this case, as the available channel is allocated fixedly in the aforementioned satellite communications system, the amount of data that it can transmit within unit time comes to be limited. Therefore, it takes much time for data transmission resulting in problems affecting the system such as degradation in transmission efficiency.

In addition, according to the aforementioned satellite communications system, what is set fixedly as an available channel of VSAT is only that either one of the plural time slots is used in addition to that it has the aforementioned uplink frequency band. Therefore, there may be a possibility of data transmission at a timing in synchronization with the same time slot from the plural VSAT and in this case data collision occurs. This phenomenon has a possibility of occurring with a relatively high frequency depending on the use time zone and the use location. Therefore, for example, in case of transmitting large quantity of data, much more time is required for such mass data transmission resulting in a further decrease of transmission efficiency.

### SUMMARY OF THE INVENTION

Hence, it is an object of the present invention to provide a method for allocating satellite channel and a satellite communications system and a earth station for satellite communications capable of transmitting mass data effectively to central station even in the occasion of transmitting mass data from a remote station to a central station in case of the forward satellite channel being set fixedly.

In order to achieve the above object, the present invention relates to a method for allocating satellite channel used in satellite communications system transmitting data bi-directionally between a central station and a plurality of remote stations via a satellite in which a plurality of first forward satellite channels used for transmitting data from said each remote station are fixedly set beforehand, comprising the step of allocating a second forward satellite channel being set beforehand with a larger capacity than said first satellite channel apart therefrom for data transmission, in case that a predetermined condition related to the data transmission from the remote station is satisfied, to the remote station satisfying said condition from the central station.

Further, the present invention relates to a satellite communications system for transmitting data from a central station to a plurality of remote stations through backward satellite channel and for transmitting data from said plurality of remote stations to said central station through a fixedly predetermined plurality of forward satellite channels, wherein the remote station includes means for transmitting a channel request data for use permission of the second satellite channel set beforehand with a larger capacity than said first satellite channel apart therefrom and the central station includes means for allocating said second forward satellite channel to the remote station for data transmission on condition that said second forward satellite channel being unoccupied.

Furthermore, the present invention relates to a satellite communications system for transmitting data from a central station to a plurality of remote stations through backward satellite channel and for transmitting data from said plurality of remote stations to said central station through a fixedly predetermined plurality of forward satellite channels, wherein the central station includes data accumulating means for accumulating respectively for each said remote station the amount of data transmitted from said remote station during the data transmission, discriminating means for discriminating whether the data accumulated by said data accumulating means exceeds a reference amount of data or not and channel allocating means for allocating a second forward satellite channel set beforehand with a larger capacity than said first forward satellite channel apart therefrom for data transmission, in case that said predetermined condition is satisfied by said discriminating means, to the remote station concerned.

Further, the present invention relates to an earth station for satellite communications transmitting data to other plurality of earth stations through backward satellite channel and receiving data transmitted from said other plurality of earth stations through a fixedly predetermined plurality of first forward satellite channels comprising judging means for judging whether a predetermined condition related to the data transmission from either one of said other earth stations is satisfied or not and channel allocating means for allocating a second forward satellite channel with a larger capacity than said first forward satellite channel apart therefrom for data transmission, in case that said predetermined condition is satisfied by said judging means, to the other earth station satisfying said condition.

According to the above architecture, it is made possible to allocate to the remote station a second forward satellite channel having a larger capacity than that of the first forward satellite channel fixedly set beforehand. Therefore, in case of transmitting mass data, the remote station can transmit the mass data concerned effectively through the second forward satellite channel.

### BRIEF DESCRIPTION OF THE DRAWINGS

FIG. 1 is a conceptual illustration showing an architecture of satellite communications system according to the first embodiment related to the present invention;

FIG. 2 is a conceptual illustration showing a frequency allocation of the satellite channel;

FIG. 3 is a conceptual illustration showing a time allocation of the first forward satellite channel;

FIG. 4 is a block diagram showing the architecture of a RUB.

FIG. 5 is a block diagram showing the architecture of a VSAT.

FIG. 6 is a time sequence diagram explaining the action between the HUB and the VSAT in case of generating a request for transmitting mass data in the VSAT.

FIG. 7 is a conceptual illustration showing a frequency allocation of the satellite channel according to the second embodiment related to the present invention;

FIG. 8 is a conceptual illustration showing a time allocation of the forward satellite channel according to the second embodiment;

FIG. 9 is a block diagram showing a architecture of a HUB according to the third embodiment related to the present invention; and

FIG. 10 is a flow chart explaining the allocation control of the second forward satellite channel according to the third embodiment.

### DETAILED DESCRIPTION OF THE PREFERRED EMBODIMENTS

Now, the embodiments of the present invention are described in detail with reference to the accompanied drawings.

(First Embodiment)

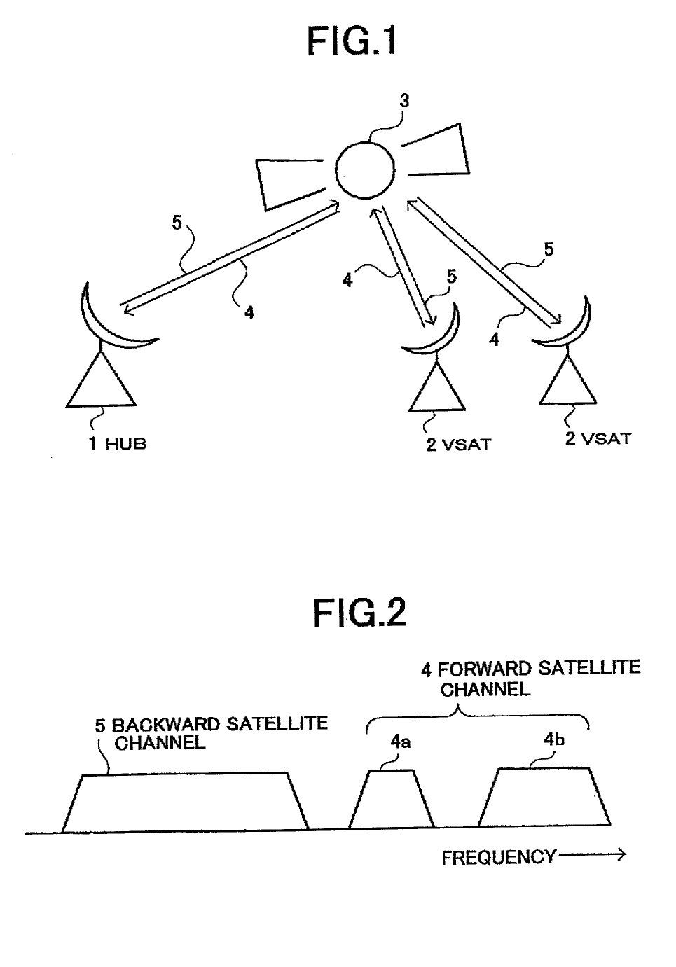

FIG. 1 is a conceptual illustration showing the system architecture of a satellite communications system according to the first embodiment related to the present invention. The satellite communications system provides various data delivery service to plural subscribers from data delivery businessmen concerned through the use of satellite. Describing in more detail, the satellite communications system comprises a central station 1 as one of the earth stations at central side (hereinafter referred to as “HUB”) and a plurality of remote stations 2 at remote side (hereinafter referred simply to as “VSAT”), and it transmits data bi-directionally between the HUB 1 and the VSAT 2 using the satellite 3 navigating on a circular orbit as a relay station.

Describing in more detail, in this satellite communications system the HUB 1 possesses various data such as picture image, music or facsimile. The VSAT 2 gives request to the HUB 1 for the data delivery of desired type from among the various data. In this case, the VSAT 2 transmits request-to-send data to the HUB 1 using forward satellite channel 4.

The HUB 1, on receiving the request-to-send data from the VSAT 2, transmits data of a type corresponding to the request concerned to the VSAT 2. In this case, the HUB 1 transmits data to the VSAT 2 using the backward satellite channel 5. To be more concrete, the HUB 1 transmits data formed according to the IP (Internet Protocol). Therefore, in this first embodiment, the HUB 1 comes to transmit the IP data to the VSAT 2.

On the other hand, the VSAT 2 informs the HUB I whether the data has been transmitted correctly at an appropriate timing or nots In this case, the VSAT 2 transmits ACK data or the like using the forward satellite channel 4. According to this satellite communications system, data delivery service is realized by means of such bi-directional data transmission.

FIG. 2 is a conceptual diagram showing a frequency allocation of the satellite channel. In this first embodiment, the backward satellite channel 5 used for data transmission from the HUB 1 to the VSAT 2 and a part of the satellite channel 4 used for data transmission from the VSAT 2 to the HUB 1 are both fixedly set beforehand.

Describing in more detail, the backward satellite channel 5 has a predetermined downlink frequency band. The downlink frequency band is set at such comparatively wide range as to transmit mass data such as picture image effectively and its transmission rate is, for example, 2 Mbps

The HUB 1 produces radio signal having an aforementioned downlink frequency band by, for example, modulating a carrier of a predetermined frequency with the data. In addition, the HUB 1 sends out the aforementioned radio signal in synchronization with either one of the plural time slots set beforehand within a predetermined frame or the plural time slots. In this case, the HUB 1 uses the time slot properly according to the individual type of the data to be transmitted. Therefore, the HUB 1 transmits the data using different backward satellite channel according to each type of the data.

The forward satellite channel 4 comprises a channel having two different frequency bands. To be more concrete, the forward satellite channel 4 is so-called SCPc (Single Channel Per Carrier) type including a first satellite channel 4a having a first uplink frequency band and a second forward satellite channel 4b having a second uplink frequency band different from the first uplink frequency band.

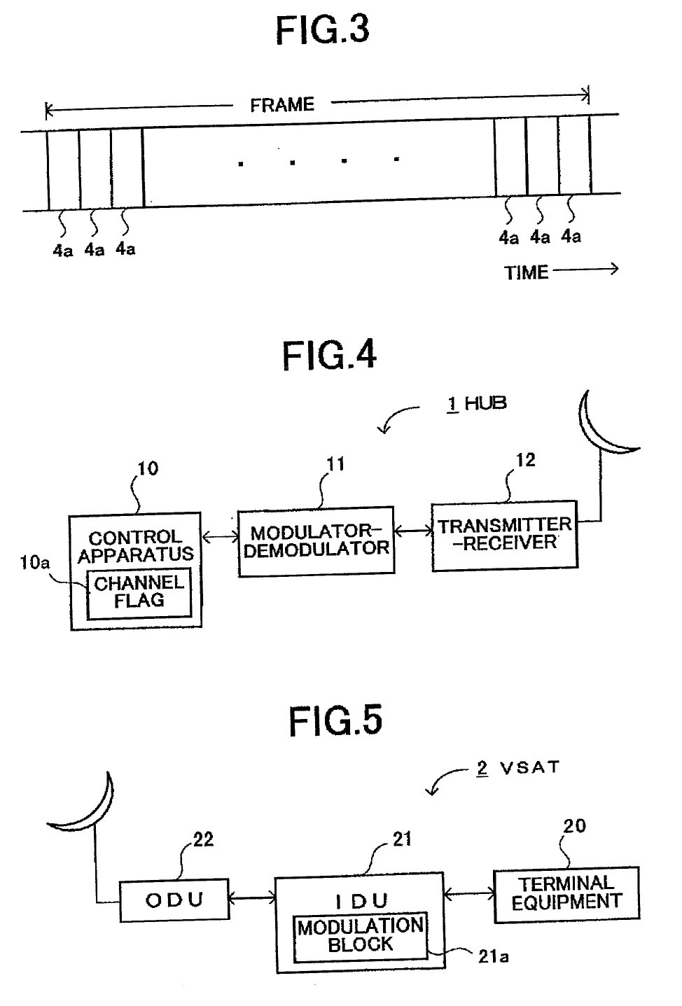

Describing in more detail, each first forward channel 4a has a first frequency band and it is fixedly set beforehand as the one corresponding to either one of the plural time slots within the predetermined frame as shown in FIG. 3. In other words, the first forward satellite channel 4a has a first uplink frequency band and corresponds to either one of the plural time slots by all means and it is impossible, for example, to allocate a different frequency band to it dynamically or to allocate dynamically so as to correspond to plural time slots according to the amount of data transmitted from the VSAT 2.

The first satellite channel 4a is used in general, namely in a case of transmitting ACK data or the like while there exists no request-to-send for mass data, and it is a channel that the plural VSAT 2 can access in a random fashion. To be concrete, in case of transmitting ACK data or the like, the VSAT 2 produces radio signal having the first uplink frequency band by modulating a carrier with the ACK data concerned. In addition, the VSAT 2 sends out the radio signal concerned at a timing in synchronization with either one of the aforementioned plural time slots. Additionally, the transmission rate of the first forward satellite channel is set at 32 kbps, 64 kbps or etc.

The second forward satellite channel 4b has, as described above, the second uplink frequency band. The second uplink frequency band is different from the first frequency band and its range is wider than that of the first uplink frequency band. In other words, the second forward satellite channel 4b has a larger capacity than that of the first forward frequency band.

The second forward satellite channel 4b is mainly used in a case that a request-to-send mass data is generated in the VSAT 2. However, the VSAT 2 can not use the second forward satellite channel 4b without restraint unlike the first forward satellite channel 4a and can use the second forward satellite channel 4b only if the use permission is obtained from the HUB 1 in response to the request for the use permission to the HUB 1. In other words, the second forward satellite channel 4b bears the role as an exclusive channel suitable for mass data transmission. As described above, this second forward satellite channel 4b possesses a wider range of frequency band than that of the first forward satellite channel 4a. Therefore, by transmitting mass data using this forward satellite channel 4b, the mass data can be transmitted effectively.

FIG. 4 is a block diagram showing the architecture of the HUB 1. The HUB 1 comprises a control apparatus 10, a modulator-demodulator 11 and a transmitter-receiver 12. The control apparatus 10 acts as the control center of the HUB 1 and consisted, for example, of a computer. The control apparatus 10 possesses various kinds of computer software and executes various soft operations such as channel allocation control as will be described later according to the computer programs. In addition, the control apparatus 10 has a function watching over the use condition of the backward satellite channel 5, the first forward satellite channel 4a and the second forward satellite channel 4b. In addition, the control apparatus 10 has a channel flag for memorizing the use condition of the second forward satellite channel 4b. The channel flag is, for example, set “1” in case of the second forward satellite channel 4b being used and set “0” in case of the second forward satellite channel 4b being not yet used.

The modulator-demodulator 11 executes the operation of modulation and demodulation. To be concrete, the modem 11 generates radio signal having downlink frequency band by modulating a carrier with data such as picture image or control data. In addition, the modulator-demodulator 11 restores the original data by demodulating the radio signal (intermediate frequency signal) transmitted from the VSAT 2. The transmitter-receiver 12 sends out the radio signal outputted from the modulator-demodulator 11 to the air after having amplified them while outputting the intermediate frequency signal translated from the received radio signal from the satellite 3.

FIG. 5 is a block diagram showing the architecture of the VSAT 2. The VSAT 2 comprises a terminal equipment 20, a IDU (Indoor Unit) 21 and a ODU (Outdoor Unit) 22. The terminal equipment 20 is, for example, consisted of a personal computer and acts as the control center of the VSAT 2. The terminal equipment 20 informs the user of the picture image, music or the like corresponding to the data delivered from the HUB 1. Furthermore, the terminal equipment 20 outputs the request-to-send and the mass data or the like to the IDU 21.

The IDU 21 performs modulation or demodulation operation. To be concrete, by modulating the data outputted from the terminal equipment 20, the IDU 21 generates radio signal including the data concerned. To be more concrete, the IDU 21 includes a modulation block 21a. The modulation block 21a generates radio signal having a first uplink frequency band or a second uplink frequency band by modulating a carrier with the request-to-send data, ACK data and mass data according to the soft setting by the IDU 21. The IDU 21 outputs the generated radio signal to the ODU 22.

Additionally, the IDU 21 comprises a demodulation block (not shown) where the radio signal (intermediate frequency signal) transmitted from the HUB 1 is demodulated to restore the original data. The IDU 21 supplies the restored original data to the terminal equipment 20. Hereby, the terminal equipment 20 can display picture on a monitor screen or output music from a loud speaker.

The ODU 22 outputs the radio signal outputted from the IDU 21 to the air after having amplified it while translating the radio signal received from the satellite 3 into the intermediate frequency signal to output it to the IDU 21.

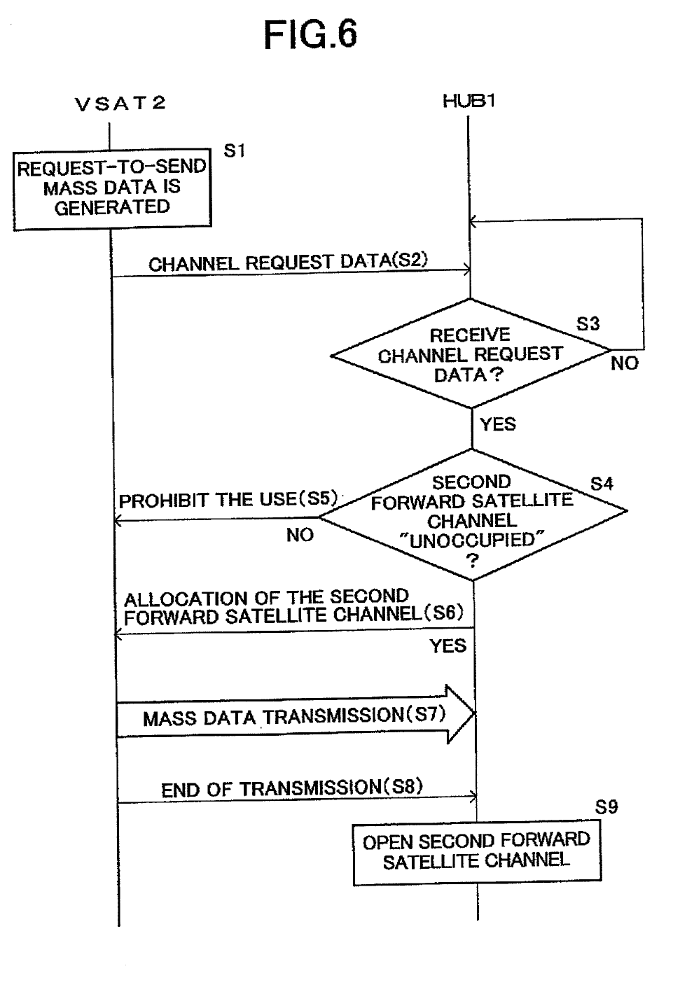

FIG. 6 is a sequence chart explaining the action between the HUB 1 and the VSAT 2 in case that a request-to-send for mass data is generated in the VSAT 2. In case that a request-to-send data for mass data is generated in the VSAT 2 (S1), the VSAT 2 asks the HUB 1 for a permission to use the second forward satellite channel 4b through the first forward satellite channel 4a (S2). To be more concrete, in case that a request-to-send for data larger than the predetermined capacity is generated, the VSAT 2 asks the HUB 1 for the aforementioned use permission. The aforementioned predetermined capacity is set at an amount that can be transmitted at a predetermined transmission rate in case of transmitting the data through the first forward satellite channel 4a. In other words, the aforementioned predetermined capacity is, for example, set at a maximum amount of data by which a predetermined transmission rate can be secured in case of transmitting the data through the first forward satellite channel 4a.

Describing in more detail about the operation related to the request for the use permission of the VSAT 2, the terminal equipment 20 of the VSAT 2 provides the IDU 21 with a channel request data showing use permission of the second forward satellite channel 4b. The IDU 21, on receiving the data from the terminal equipment 20, determines the amount of data. In this case, as the amount of data concerned is not an amount corresponding to the mass data, the IDU 21 sets a carrier frequency, transmission rate or the like for the modulation block 21a in order that a radio signal having the first uplink frequency band can be generated. In addition, the IDU 21 provides the modulation block 21a with the data concerned in response to the tinting in synchronization with either one of the plural time slots. As a result, the modulation block 21a generates radio signal having the first uplink frequency band by performing modulation based on the channel request data concerned. The generated radio signal is sent out to the air through the ODU 22. Consequently, the radio signal concerned is received by the HUB 1 via the satellite 3.

The HUB 1 discriminates whether the predetermined condition related to the data transmission by the VSAT 2 is satisfied or not (S3, S4), and in case that the condition is satisfied, it allocates the second forward satellite channel 4b to the VSAT 2 having satisfied with the condition concerned. The predetermined condition is that the request-to-send for mass data is generated in the VSAT 2 and that the second forward satellite channel 4b is unoccupied. In other words, the aforementioned predetermined condition is that the radio signal including the channel request data is received from the VSAT 2 and that the second forward satellite channel 4b is unoccupied. The HUB 1 allocates the second forward satellite channel 4b suitable for the mass data transmission to the VSAT 2 in case that the condition is satisfied.

Describing in more detail, the HUB 1 discriminates whether the radio signal including the channel request data is received or not (S3). In case that the radio signal concerned is received, the HUB 1 judges whether the second forward satellite channel 4b is not used by other VSAT 2 (S4). In other words, the HUB 1 discriminates whether the second forward satellite channel is occupied or not. If it is occupied, the HUB 1 transmits the radio signal including the use prohibition data showing that the use is not permitted to the VSAT 2 concerned through the backward satellite channel 5 (S5). On the other hand, if it is unoccupied, the HUB 1 transmits the radio signal including the allocation data for permitting the allocation of the second forward satellite channel 4b to the VSAT 2 concerned through the backward satellite channel 5 (S6).

Explaining in more detail the process in the HUB 1, in case that the transmitter-receiver 12 of the HUB 1 receives the aforementioned radio signal, the, transmitter-receiver 12 translates the radio signal concerned into the intermediate frequency signal and outputs the intermediate frequency signal concerned to the modulator-demodulator 11. The modulator-demodulator 11 restores the original channel request data by demodulating the intermediate frequency signal concerned and outputs it to the control apparatus 10. The control apparatus 10, on receiving the channel request data, discriminates whether the second forward satellite channel 4b is unoccupied with reference to the channel flag la or not.

If the channel flag 10a is set “0” namely the second forward satellite channel is occupied, the control apparatus 10 outputs use prohibition data to the modulator-demodulator 11. On the other hand, if the channel flag 10a is set “1”, namely the second forward satellite channel is unoccupied, the control apparatus 10 outputs the allocation data to the modulator-demodulator 11. The modulator-demodulator 11 generates the radio signal having the downlink frequency band by performing the modulation based on the use prohibition data or the allocation data and sends out the radio signal concerned to the air from the transmitter-receiver 12. As a result, the radio signal concerned comes to be received by the VSAT 2 via the satellite 3.

The VSAT 2, on receiving the radio signal including the allocation data, transmits the mass data to be transmitted to the HUB 1 successively through the second forward satellite channel 4b. In other words, the VSAT 2 that received the permission for the allocation of the second forward satellite channel 4b occupies the second forward satellite channel 4b. To be more concrete, the IDU 2 of the VSAT 2, on receiving the radio signal including the allocation data, translates the radio signal concerned into the intermediate frequency signal thereby outputting it to the IDU2. The IDU 2 restores the original allocation data by modulating the intermediate frequency data and outputs it to the terminal equipment 20.

The terminal equipment 20, on receiving the allocation data, provides the mass data to be transmitted successively to the IDU 21 in response to that. The IDU2 determines the quantity of the data provided from the terminal equipment 20. In this case, as the data has a volume corresponding to the mass data, the IDU 21 sets the carrier frequency, the transmission rate or the like for the modulation block 21a in order to generate radio signal having the second uplink frequency band, and provides the data concerned to the modulation block 21a successively. As a result, the modulation block 21a generates the radio signal having the second uplink frequency band by performing the modulation based on the mass data. The radio signal is sent out successively to the air through the ODU 2. As a result, the radio signal concerned comes to be received by the HUB 1 via the satellite 3.

As described above, the VSAT 2 can transmit mass data through the exclusive second forward satellite channel 4b. Therefore, the VSAT 2 can transmit mass data-at a higher rate than in the case using the first forward satellite channel 4a. Consequently, the VSAT 2 can transmit even such mass data to the HUB 1 within a short time period. Moreover, as it occupies the second forward satellite channel, the collision with the data transmitted from other VSAT can be avoided. Therefore, there remains almost no need for performing an operation involving delayed data such as retransmission. Therefore, the mass data transmission within short time period can be made more steadily

The VSAT 2, having finished the mass data transmission, transmits the transmission end data showing the termination of the transmission to the HUB 1 through the first forward satellite channel 4a (S8). The HUB 1, on receiving the transmission end signal, opens the second forward satellite channel 4b having been allocated to the VSAT 2 theretofore (S9). Thus, the second forward satellite channel 4b becomes ready for the coming use.

Explaining concretely in more detail the process of the VSAT 2 and the HUB 1, the terminal equipment 20 of the VSAT 2 outputs the transmission end data to the modulation block 21a of the IDU 21 at a timing in synchronization with any given time slot. The modulation block 21a generates radio signal having the first uplink frequency band by performing the modulation based on the transmission end data concerned. The radio signal concerned is sent out to the air through the ODU 22 and received by the HUB 1 via the satellite 3.

The transmitter-receiver 12 of the HUB 1, on receiving the radio signal, translates the radio signal concerned into the intermediate frequency signal thereby outputting it to the modulator-demodulator 11. The modulator-demodulator 11 restores the original transmission end data from the intermediate frequency signal and outputs it to the control apparatus 10. The control apparatus 10, on receiving the transmission end data concerned, opens the second forward satellite channel and turns the setting of the channel flag from “1” to “0”.

As described above, according to the first embodiment, an exclusive second forward satellite channel suitable for mass data transmission is allocated for the VSAT 2 in response to the request from the VSAT 2. Therefore, the VSAT 2 can transmit mass data effectively. In other words, the VSAT 2 can transmit mass data within a short time period. Accordingly, the VSAT 2 can afford improved services to the user thereof.

Additionally, as the mass data can be transmitted from the VSAT 2 to the HUB 1, it goes without spending much time for the interconnection between the VSAT 2 and the HUB 1. Consequently, the VSAT 2 and the HUB 1 becomes easy to interconnect to each other. Therefore, the capacity available for the subscribers can be increased.

Further, as the HUB 1 is required only to judge whether the second satellite channel should be allocated in response to the reception of the radio signal including the channel request data from the VSAT 2, a troublesome operation such as the observation for the amount of the data or the like can be spared. Thereby, an effective data transmission can be realized without putting a burden on the HUB 1.

(Second Embodiment)

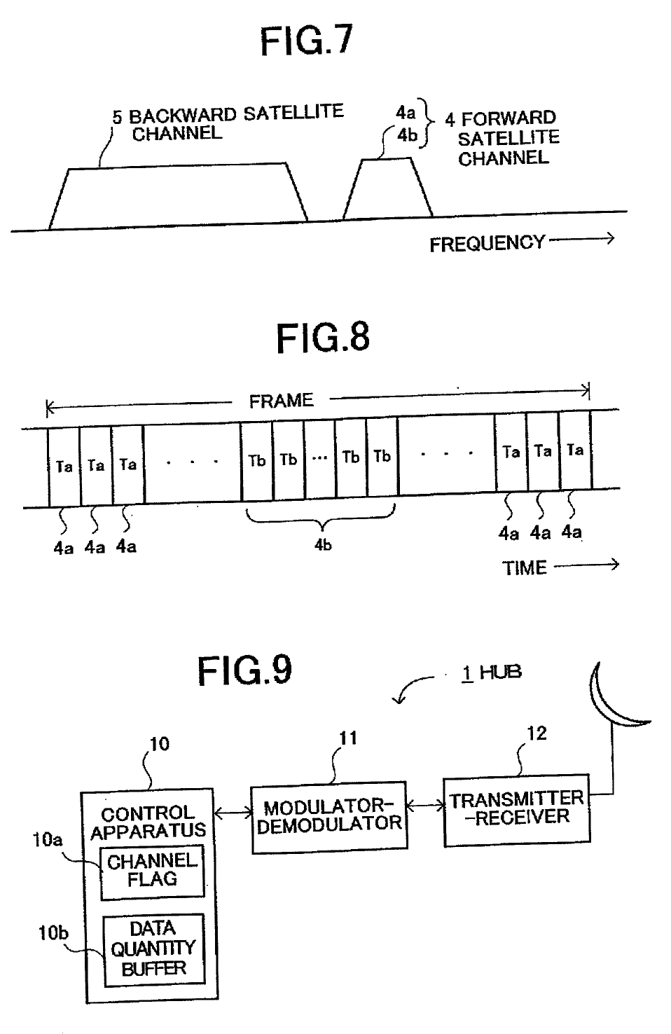

FIG. 7 is a conceptual illustration showing the frequency allocation of the satellite channel related to the second embodiment according to the present invention.

According to the first embodiment, the first and the second forward satellite channel 4a, 4b is separated by means of making a difference between their frequency bands. In contrast to this, according to the second embodiment, the first and the second forward satellite channels 4a, 4b are separated by means of making a difference between their time slots. Describing in more detail, both of the first and the second forward satellite channels 4a, 4b related to the second embodiment has a common uplink frequency band and each corresponds to a time slot differing with each other among plural time slots.

To be more concrete, the aforementioned uplink frequency bands corresponding to the first and the second forward satellite channels 4a, 4b, for example, correspond to the first uplink frequency band in the first embodiment. Additionally, in the second embodiment, a plurality of time slots within a frame is separated, as shown in FIG. 8, into a time slot Ta exclusive for the first forward satellite channel 4a and a time slot Tb exclusive for the second forward satellite channel 4b.

Each of the plural forward satellite channels 4a corresponds respectively to m (for example, m=1) pieces of time slots among the plural time slots for exclusive use of the first forward satellite channel. On the other hand, the time slot Tb for the exclusive use of the second forward satellite channel corresponds to n (for example, n=5) pieces of time slots, the number of which is at least greater than m. In other word, for example, in case that the time slot Ta is composed of one time slot, the time slot Tb is composed of plural time slots. As described above, the second forward satellite channel is composed of greater number of the time slots than that of the first forward satellite channel so that it is a channel of greater capacity than the first forward satellite channel. Therefore, in this case also, the second forward satellite channel bears the role as a channel for exclusive use suitable for mass data transmission. The time slot Tb for exclusive use of the second forward satellite channel 4b may either be continuous or discrete in time.

According to the aforementioned embodiment, the IDU 21 supplies mass data successively to the modulation block 21a upon using the second forward satellite channel 4b. In contrast to this, according to the second embodiment, the IDU 21 supplies mass data at a timing in synchronization with the time slot for exclusive use of the second forward satellite channel. Hereby, the mass data can be transmitted to the HUB 1 through the second forward satellite channel.

As described above, according to the second embodiment, the second forward satellite channel 4b has the same uplink frequency band as the first forward satellite channel 4a and it is set as a channel having a larger capacity than the first forward satellite channel 4a. In other words, the frequency band for exclusive use of the second forward satellite channel 4b is not set on purpose. Therefore, it becomes possible to plan a more effective utilization of the frequency resources in comparison with the aforementioned first embodiment.

(Third Embodiment)

FIG. 9 is a block diagram showing the architecture of the HUB 1 related to the third embodiment according to the present invention. In FIG. 9, sane reference numerals are used for those having the same function as in FIG. 4.

In the aforementioned first and second embodiments, in case that a use permission of the channel is requested from the VSAT 2 to the HUB 1, the second forward satellite channel 4b is allocated for the VSAT 2 concerned on condition that the channel being unoccupied. In contrast to this, according to the third embodiment, the second forward satellite channel 4b comes to be allocated for the VSAT 2 concerned on condition that the channel being unoccupied in case that there exists large amount of data to be transmitted from the VSAT 2 during the data transmission.

Incidentally, the second forward satellite channel 4b related to the third embodiment may also be the one explained in the first embodiment having different frequency band from the first forward satellite channel 4a or also may be the one explained in the second embodiment corresponding to the plural time slots Tb different from that of the first forward satellite channel 4a while having the same frequency band as the first forward satellite channel.

The HUB 1 according to the third embodiment is provided with data amount buffer 10b within the control apparatus 10. The data amount buffer 10b accumulates the amount of data transmitted from the plural VSAT 2 by corresponding them to each VSAT 2. To be more concrete, in the amount of data buffer 10b, each amount of data is accumulated in one to one correspondence with each VSAT 2.

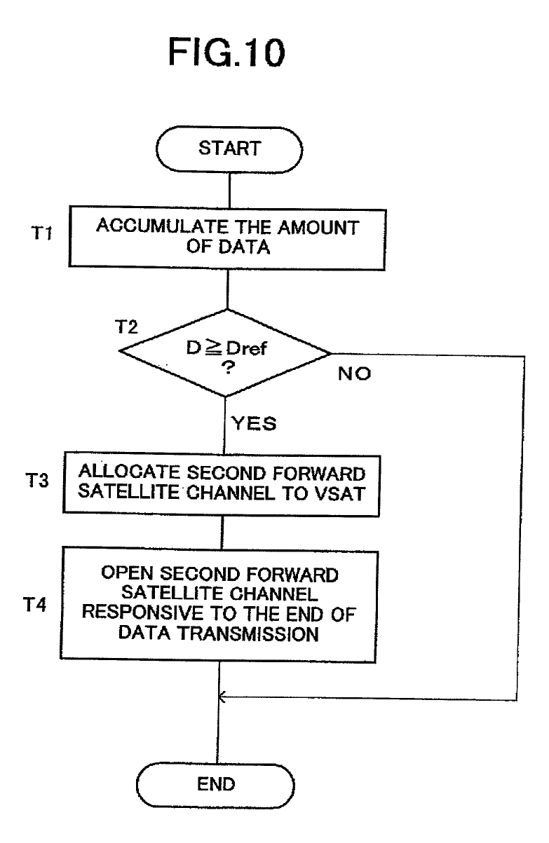

FIG. 10 is a flow chart explaining the allocation control of the second forward satellite channel 4b related to the third embodiment. In case that a request-to-send data is provided from the VSAT 2 to the HUB 1. The HUB 1 receives the request-to-send data from the VSAT 2. The HUB 1, on receiving the request-to-send data, transmits the data to the VSAT 2 and starts the watching over the amount of data transmitted from the VSAT 2. To be more concrete, the HUD 1, on receiving the data transmitted from each VSAT 2, acquires the amount of data concerned and stores the acquired amount of data concerned in the data amount butter 10b (step T1).

While the data being transmitted from the HUB 1 to the VSAT 2, the VSAT 2 transmits a control data having comparatively low capacity such as ACK data indicating the normal reception of the data. However, there may be a case that a relatively massive data is transmitted to the HUB 1 for some reason. Additionally, the first forward satellite channel is used for transmitting the aforementioned control data to the HUB 1 but because the first forward satellite channel 4a is a random access channel, there may be a possibility of collision with the data transmitted from other VSAT 2. In this case, the HUB 1 asks VSAT 2 for a request-to-resend. In response to this, the VSAT 2 transmits the same control data repeatedly to the HUB 1. As a result, relatively massive data comes to be transmitted in comparison with the case going without retransmission.

As described above, a comparatively large quantity of data is transmitted from the VSAT 2 to the HUB 1 in some cases. In this case, an effective data transmission can not be achieved by way of the first forward satellite channel. Therefore, in this third embodiment, it is checked if a comparatively massive data is transmitted from the VSAT 2 by accumulating the amount of data transmitted from the VSAT 2.

Next, the control apparatus 10 of the HUB 1 compares the accumulated data capacity (hereinafter referred to as “accumulated amount of data”) D with the predetermined reference amount of data Dref. To be more concrete, the HUB 1 judges if the accumulated amount of data D is equal to or more than the aforementioned reference amount of data Dref (step T2). The reference amount of data Dref is set at an amount enabling the data transmission at a predetermined transmission rate in case of transmitting the data through the first forward satellite channel 4a. In other words, the reference amount of data Dref is set at an amount that makes it possible to secure a desired data transmission rate in case of transmitting the data through the first forward satellite channel 4a.

If the accumulated amount of data D is less than the aforementioned reference amount of data Dref, the control apparatus does not perform the allocation of the second forward satellite channel 4b. This is because that the data can be transmitted effectively through the first forward satellite channel 4a. On the other hand, if the accumulated amount of data D is equal to or more than the aforementioned amount of data Dref, the control apparatus allocates the second forward satellite channel 4b to the VSAT 2 whose accumulated amount of data D is less than the reference amount of data Dref (step T3).

To be concrete, the control apparatus 10 transmits an indication data suggesting the use of the second forward satellite channel 4b through the backward satellite channel 5 by addressing the VSAT 2 where the accumulated amount of data D is equal to or more than the aforementioned reference amount of data Dref. The VSAT 2 concerned, on receiving the indication data, transmits the ACK data to the HUB 1 and performs the succeeding data transmission using the second forward satellite channel 4b.

As described above, in case of satisfying the predetermined condition related to the data transmission from the VSAT 2 that the accumulated amount of data D is equal to or more than the reference amount of data Dref, the HUB 1 allocates the second forward satellite channel 4b to the VSAT 2 that has satisfied the condition concerned. Therefore, after the allocation of the second forward satellite channel, the data transmission from the VSAT 2 concerned to the HUB 1 can be carried out smoothly. In other words, the VSAT 2 can transmit mass data effectively to the HUB 1.

The VSAT 2 transmits transmission end data indicating the termination of the transmission to the HUB 1 through the first forward satellite channel 4a. The HUB 1, on receiving the transmission end data, opens the second forward satellite channel 4b which has been allocated to the VSAT 2 concerned theretofore (step T4). Hereby, the second forward satellite channel 4b becomes ready for the next use.

As described above, according to the third embodiment, examining if a comparatively massive data is being transmitted from the VSAT 2 during the data transmission so as to allocate the second forward satellite channel corresponding to the mass data transmission to the VSAT 2 concerned in case that the comparatively massive data is being transmitted. Therefore, the VSAT 2 can transmit mass data effectively using the second forward satellite channel 4b concerned. Consequently, it becomes possible to plan an improvement in services to users of the VSAT 2.

In addition, it is discriminated whether the mass data is being transmitted from the VSAT 2 by comparing the amount of data D with the reference amount of data Dref. In other words, as it is made possible to discriminate whether the data has a large amount merely by performing a simple comparison, the discrimination can be performed by a simple operation without putting a great burden to the HUB 1.

Furthermore, VSAT 2 can get along only by changing the channel for use according to the indication from the HUB 1 without taking a notice whether the data to be transmitted is massive. Therefore, mass data can be transmitted effectively without putting a great burden on the VSAT 2.

Furthermore, as the reference amount of data Dref is set from the viewpoint of transmission efficiency, the reference amount of data can be set according to the transmission efficiency required for the satellite communications system. Therefore, it is possible to decide voluntarily whether the second forward satellite channel should be used according to the satellite communications system.

The explanation of the embodiments according to the present invention is described as above but the present invention should not be restricted to the above embodiments. For example, in the above embodiments, the present invention is described by way of example as a satellite communications system comprising a single HUB. However, the present invention is also applicable without difficulty, for example, to a satellite communications system comprising a plurality of HUB.

In addition, in the above embodiments, an example is described in which the IP data is used as the data transmitted from the HUB 1 to the VSAT 2. However, as for the data transmitted from the HUB 1 to the VSAT 2 can be, for example, a telemeter data or a telecontrol data other than the IP data.

What is claimed is:

1. A method for allocating satellite channel used in satellite communications system transmitting data bi-directionally between central station and a plurality of remote stations via a satellite in which a plurality of first forward satellite channels used for transmitting data from said each remote station are fixedly set beforehand, comprising the step of allocating a second forward satellite channel set beforehand with a larger capacity than that of said first satellite channel apart therefrom for data transmission, in case that a predetermined condition related to the data transmission from the remote station is satisfied, to the remote station satisfying said condition from the central station.

2. A satellite communications system for transmitting data from a central station to a plurality of remote stations through backward satellite channel and for transmitting data from said plurality of remote stations to said central station through a fixedly predetermined plurality of forward satellite channels, wherein:
said remote station includes means for transmitting a channel request data for use permission of the second satellite channel being set beforehand apart from said first forward satellite channel and having a larger capacity than that of said first satellite channel; and
said central channel includes means for allocating said second forward satellite channel for the purpose of data transmission to the remote station on condition that said second forward satellite channel being unoccupied.

3. The satellite communications system according to claim 2, wherein:
said means for transmitting said channel request data transmits said channel request data to said central station in case that a request-to-send data larger than a predetermined capacity is generated; and
said second forward satellite channel is a channel for transmitting said data larger than the predetermined capacity.

4. The satellite communications system according to claim 2, wherein:
said plurality of first forward satellite channel corresponds to a predetermined first uplink frequency band and also corresponds to either one of the plural time slots set within a predetermined frame; and
said second forward satellite channel corresponds to a second uplink frequency band different from said first forward frequency band.

5. The satellite communications system according to claim 2, wherein:
said plurality of first forward satellite channel corresponds to a predetermined first uplink frequency band and to m pieces among the plural time slot set within a predetermined frame; and
said second forward satellite channel corresponds to n (n>m) pieces of the time slot other than said time slots set within said first uplink frequency band.

6. A satellite communications system for transmitting data from a central station to a plurality of remote stations through backward satellite channel and for transmitting data from said plurality of remote stations to said central station through a fixedly predetermined plurality of forward satellite channels, wherein said central station comprising:
data accumulating means for accumulating respectively in each said remote station the amount of data transmitted from said remote station during the data transmission;
discriminating means for discriminating whether the data accumulated by said data accumulating means exceeds a reference amount of data or not; and
channel allocating means for allocating a second forward satellite channel set beforehand with a larger capacity than said first forward satellite channel apart therefrom to said remote station for data transmission in case that said accumulated amount of data is discriminated to exceed said reference amount of data by said discriminating means.

7. The satellite communications system according to claim 6, wherein:
said plurality of first forward satellite channel corresponds to a predetermined first uplink frequency band and to the plural time slots set within a predetermined frame; and
said second forward satellite channel corresponds to a second uplink frequency band different from said first uplink frequency band.

8. The satellite communications system according to claim 6, wherein:
said plurality of first forward satellite channel corresponds to a predetermined first uplink frequency band and to m pieces among the plural time slots set within a predetermined frame; and
said second forward satellite channel corresponds to n (n>m) pieces of time slot other than said time slots set within said first uplink frequency band.

9. An earth station for satellite communications transmitting data to other plurality of earth stations through backward satellite channel and receiving the data transmitted from said other plurality of earth stations through fixedly predetermined plurality of first forward satellite channels comprising:
discriminating means for discriminating whether a predetermined condition related to the data transmission from either one of said other earth stations is satisfied or not;
channel allocating means for allocating transmission a second forward satellite channel set beforehand with a larger capacity than that of said first forward satellite channel apart therefrom for data transmission in case that said predetermined condition is satisfied by said discriminating means, to the other earth station satisfying said condition.
